(19) United States
(12) Patent Application Publication
(10) Pub. No.: US 2025/0182427 A1
(43) Pub. Date: Jun. 5, 2025

(54) SYSTEMS AND METHODS FOR GENERATING AMBIENCE SUGGESTIONS FOR AN ENVIRONMENT

(71) Applicant: Samsung Electronics Co., Ltd., Suwon-si (KR)

(72) Inventors: Shivani AGGARWAL, Noida (IN); Pushpinder GOYAL, Noida (IN); Sumantra DASGUPTA, Noida (IN)

(21) Appl. No.: 19/049,590

(22) Filed: Feb. 10, 2025

Related U.S. Application Data
(63) Continuation of application No. PCT/KR2023/018271, filed on Nov. 14, 2023.

(30) Foreign Application Priority Data
Dec. 9, 2022 (IN) 202211071100

(51) Int. Cl. G06T 19/20; G06T 15/20

(52) U.S. Cl. CPC G06T 19/20; G06T 15/205; G06T 2200/24; G06T 2210/04; G06T 2219/2004; G06T 2219/2016; G06T 2219/2024

(57) ABSTRACT

A system and a method for generating an ambience suggestion for an environment is provided. The method includes: processing image frames corresponding to the environment to identify objects in the environment; determining a fitness score corresponding to each object; determining a first ambience score based on the fitness scores; identifying a target space in the environment based on the fitness scores corresponding to the objects; generating an object arrangement for the target space; determining a second ambience score of the environment based on the object arrangement; comparing the first and the second ambience scores; and recommending the ambience suggestion based on the generated object arrangement based on determining that the second ambience score is greater than the first ambience score.

### CROSS-REFERENCE TO RELATED APPLICATIONS

This application is a continuation of International Application No. PCT/KR2023/018271 designating the United States, filed on Nov. 14, 2023, in the Korean Intellectual Property Receiving Office and claiming priority to Indian Patent Application number 202211071100, filed on Dec. 9, 2022, in the Indian Patent Office, the disclosures of each of which are incorporated by reference herein in their entireties.

### BACKGROUND

### Field

The disclosure relates to a personalization of user ambience and for example, to systems and methods for generating ambience suggestion(s) for an environment corresponding to a user.

### Description of Related Art

Personalized and managed ambience plays an important role in a person's life. For example, such ambience keeps the lifestyle of the person modern and stylish. Moreover, such a personalized and managed ambience provides elegance and comfort to the person's lifestyle.

Augmented Reality (AR) which has been a widely accepted technology enables the person to re-imagine and re-design his/her environment. For example, such technology enables the person to visualize new paint, decor, and furniture in his/her environment. Further, some AR-enabled solutions enable the user to visualize his/her environment in a 3D virtual environment.

However, none of the existing techniques provides an efficient way of managing, enhancing, and/or personalizing the ambience of the person. Accordingly, there is a need for a technique to address the above-mentioned problems.

### SUMMARY

According to an example embodiment of the present disclosure, a method for generating an ambience suggestion for an environment is disclosed. The method includes: processing one or more image frames corresponding to the environment to identify one or more objects in the environment; determining a fitness score corresponding to each of the one or more objects based on one or more parameters; determining a first ambience score based on the determined fitness scores corresponding to the one or more objects; identifying a target space in the environment based on the determined fitness scores corresponding to the one or more objects; generating an object arrangement for the target space based on the environment; determining a second ambience score of the environment based on the generated object arrangement; comparing the first ambience score and the second ambience score; and recommending the ambience suggestion based on the generated object arrangement based on determining that the second ambience score is greater than the first ambience score, wherein ambience suggestion is indicative of a change in the environment based on the generated object arrangement.

According to an example embodiment of the present disclosure, a system for generating an ambience suggestion for an environment is disclosed. The system includes: a memory and at least one processor, comprising processing circuitry, operably coupled to the memory, wherein at least one processor, individually and/or collectively, is configured to: process one or more image frames corresponding to the environment to identify one or more objects in the environment; determine a fitness score corresponding to each of the one or more objects based on one or more parameters; determine a first ambience score based on the determined fitness scores corresponding to the one or more objects; identify a target space in the environment based on the determined fitness scores corresponding to the one or more objects; generate an object arrangement for the target space based on the environment; determine a second ambience score of the environment based on the generated object arrangement; compare the first ambience score and the second ambience score; and recommend the ambience suggestion based on the generated object arrangement based on determining that the second ambience score is greater than the first ambience score, wherein the ambience suggestion is indicative of a change in the environment based on the generated object arrangement.

Various advantages and features of various example embodiments of the disclosure including a more detailed description will be rendered by reference to to the appended drawings. It is appreciated that these drawings depict only example embodiments and are therefore not to be considered limiting of its scope. The disclosure will be described and explained with additional specificity and detail with reference to the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, an in which:

FIG. 1 is a diagram illustrating an example environment of a system for generating an ambience suggestion for an environment, according to various embodiments;

FIG. 2 is a block diagram illustrating an example configuration of a system for generating the ambience suggestion for the environment, according to various embodiments;

FIG. 3 is block diagram illustrating an example configuration of modules of a system for generating the ambience suggestion for the environment, according to various embodiments;

FIGS. 4A, 4B, 4C and 4D is a flowchart illustrating example operations for generating the ambience suggestion for the environment, according to various embodiments;

FIGS. 5A and 5B is a flowchart illustrating an example method for generating the ambience suggestion for the environment, according to various embodiments;

FIG. 6 is a diagram illustrating generation of ambience suggestions for the environment, according to various embodiments;

FIG. 7 is a diagram illustrating generation of ambience suggestions for the environment, according to various embodiments;

FIG. 8 is a diagram illustrating generation of ambience suggestions for the environment, according to various embodiments;

FIG. 9 is a diagram illustrating example generation of ambience suggestions for the environment based on user activity, according to various embodiments;

FIG. 10 is a diagram illustrating example generation of ambience suggestions for the environment based on user voice command, according to various embodiments; and

FIG. 11 is a diagram illustrating example generation of ambience suggestions for the environment in a virtual reality device, according to various embodiments.

Further, one skilled in the art will appreciate that elements in the drawings are illustrated for simplicity and may not have necessarily been drawn to scale. For example, the flowcharts illustrate the method in terms of steps involved to help to improve understanding of aspects of the present disclosure. Furthermore, in terms of the construction of the device, one or more components of the device may have been represented in the drawings by conventional symbols, and the drawings may show those specific details that are pertinent to understanding the various embodiments so as not to obscure the drawings with details that will be readily apparent to those skilled in the art having the benefit of the description herein.

### DETAILED DESCRIPTION

Reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic being included in at least an embodiment. Thus, appearances of the phrase “in an embodiment”, “in another embodiment” and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The disclosure relates, for example, to a method and a system for recommending ambience suggestions to provide a managed and personalized environment to a user. Embodiments include identifying a target space in the environment to make suitable suggestions for modification in the environment. The system enhances the overall user experience in the environment and provides a more personalized and planned environment. The system takes into consideration user's interest, user's activity and user's media watching history while generating ambience recommendations for the environment. Further, various embodiments provide a simple and cost-effective technique to improve user experience in an environment.

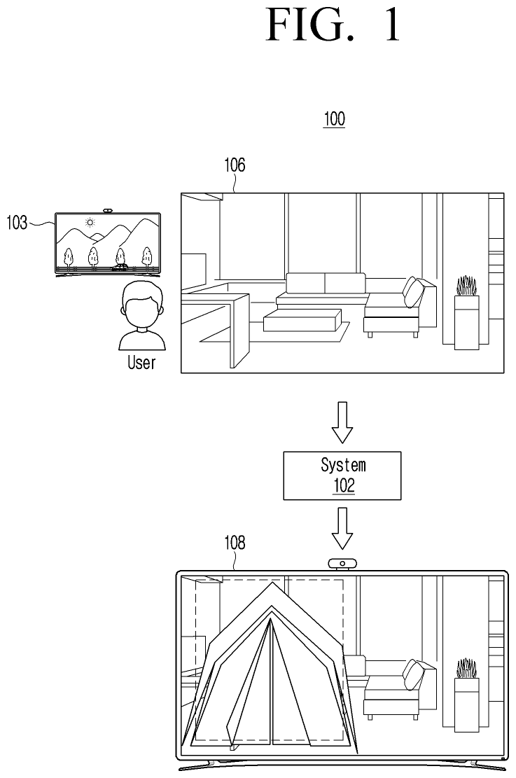

FIG. 1 is a diagram illustrating an example environment 100 of a system 102 for generating an ambience suggestion for an environment, according to various embodiments.

FIG. 1 illustrates a user watching a television 103 coupled with a camera device 104. The camera device 104 may be configured to capture image frame(s) corresponding to an environment 106. In an embodiment, the camera device 104 may be configured to capture image frames at a predetermined interval of time. Further, the environment 106 may correspond to a room where the television 103 is installed. Examples of environment may include, but not limited to, a study room, a dining hall, a bedroom and so forth. Further, in the illustrated embodiment, the camera device 104 may be placed atop of the television 103. However, the disclosure is not limited to the illustrated embodiment. Further, the television 103 may also be configured to log user watching history. The television 103 may be configured to determine and store user interest based on content viewed by the user. Further, the television 103 is an example and embodiments either covers or intend to cover any other suitable display and/or media device. Example of media devices may include, but not limited to, personal computer, smart watch, voice assistant device, Internet of thing (IoT) device, laptop, and so forth.

The system 102 may be configured to receive the image frames captured by the camera device 104. Further, the system 102 may be configured to receive information collected and stored by the television 103. In an embodiment, the system 102 may be installed within the television device 103 where the camera device 104 is installed. The system 102 may be configured to log user watching history. The system 102 may be configured to determine and store user interests based on content viewed by the user.

In an embodiment, the system 102 may be a standalone entity remotely coupled to the camera device 104 and television 103. In an embodiment, the system 102 may be installed within a mobile device of the user.

In an example embodiment, the system 102 may be configured to process the image frames captured by the camera device 104 to identify object(s) in the environment. In the illustrated embodiment, the identified objects may include, but not limited to, chairs, a table, a lamp, a cupboard and so forth. The system 102 may determine a fitness score corresponding to each identified object. The fitness score may be indicative of how aesthetically pleasing an object is with respect to the environment. In an embodiment, the fitness score may be an indicative of usefulness of the object in the environment. The usefulness of the object may be a measure of the usage of the object by the user in the environment. For example, in case a lamp is not in use by the user for a predefined (e.g., specified) long period of time, the lamp may have minimum usefulness in the environment. The fitness score may consider various parameters associated with the object such as, but not limited to, spacing, usage, form, light, color, texture, and pattern. In an example embodiment, the fitness score may be determined based on one or more parameters including, but not limited to, environment theme, user interest, object location, and object usage.

In an example embodiment, the fitness score may be determined using equation 1, below:

$${f}_{final} = {\sum }_{objects} {f}_{Objects} / N ( Number Of Objects ) \\ {f}_{Objects} = {T}_{Theme} + {UI}_{User Interest} + {L}_{Location} + {U}_{Usages} + {OF}_{OtherFectors} \qquad Eq 1$$

Here T_{Theme} may correspond to theme of the environment (interchangeably referred to as room). The theme of the environment may be based on wall color, group of object theme, lighting etc.

UI_{User Interest} may correspond to interest level of the user in the object/activity/environment.

L_{Location} may correspond to a location of the object.

OF_{Other Factors} may correspond to additional factors related to object such as, but not limited to, cost, reachability, etc.

Zero may represent a lowest value of any component in Eq. 1.

One may represent a highest value of any component in Eq.1.

F-_{final}—may represent a final fitness score of all the objects or an ambience score of the environment.

The T_{Theme} may include a value corresponding to a category/theme of the environment, such as, but not limited to, festive, living, personal usage, bedroom, dining, activity and so forth. In an example embodiment, a numeric value corresponding to the categories of the environment may be assigned to the variable T_{Theme} using any other suitable technique such as, but not limited to, one-hot encoding technique. The one hot encoding technique may assign a binary vector of length n to the variable T_{Theme} based on a number of themes/categories. Here, n may be defined as cardinality of set of themes/categories.

The UI_{User Interest} may include a value corresponding to a category which may relate to an object, an activity, or an environment. Examples of the categories for determining the value of U_{User Interest} may include, but not limited to, home decor, traveller, spiritual, homebody, sportsman, party lover, photography, art, technology, gardening, animal, and books. In an example embodiment, a numeric value corresponding to the different categories of U_{User Interest} may be assigned to the variable U_{User Interest} using any other suitable technique such as, but not limited to, one-hot encoding technique. The one hot encoding technique may assign a binary vector of length m to the variable U_{User Interest} based on a number of categories used for defining user interest. Here, m may be defined as cardinality of set of categories corresponding to user interest.

The value of L_{Location} may be determined during determination of object position. Further, the value of L_{Location} may be dependent on a position of the user in the environment. Furthermore, the value of L_{Location} may be either discrete or Boolean in nature. In an example embodiment, the objects may be classified into two types, namely container or contained. The container object may be configured to store various contained objects. For example, a bookshelf may be considered as a container object and books may be classified as contained objects. For a container type of object, the value of L_{Location} may be either accessible or not accessible. Further, for a contained type of object, the value of L_{Location} may be misplaced or properly placed. Further, a numerical and/or logical value may be assigned to the L_{Location} based on determined value. For example, for an inaccessible object, the value of L_{Location} may be defined as zero, and for an accessible object, the value of L_{Location} may be defined as one.

U_{usage} may correspond to a value which defines usability of the object in the environment. The value of U_{usage} may be defined in binary format, where a low usability of the object may be defined as zero and a high usability of the object may be defined as one.

In an embodiment, the OF_{Other Factors} may correspond to a property of the identified object such as, but not limited to, cost of the object, condition of the object, and so forth. The value of OF_{Other Factors} based on the cost of the object may be numerical and defined as a positive real number. The value of OF_{Other Factors} based on the condition of the object may be either discrete or Boolean in nature. For example, the value of OF_{Other Factors} based on the condition of the object may be either good or bad. Such values of OF_{Other Factors} may be suitably converted into numbers using suitable technique such as, but not limited to, one-hot encoding technique. Furthermore, examples described above are examples and the different variables/parameters used for determining the value of fitness score may have any suitable value as per implementation or the requirement. In an embodiment, for an expensive object, a value of OF_{Other Factors} may be defined as zero, and for an affordable object, the value of OF_{Other Factors} may be defined as one. Further, the value of OF_{Other Factors} based on cost may be subject to user profile and may vary from user to user. Further, a value of OF_{Other Factors} based on condition of object may be defined as zero for worn object and one for good object.

In various embodiments, the fitness score of the object may be defined by following equations Eq2-Eq5:

$${f}_{Object} = w 1 * {T}_{Theme} + w 2 * {UI}_{User Interest} + w 3 * {L}_{Location} + w 4 * {U}_{Usages} + w 5 * {OF}_{OtherFectors} \qquad eq 2$$

Here, w1-w5 may define weights corresponding to each variable.

$${f}_{Object} = {T}_{Theme} + {UI}_{User Interest} \qquad eq 3$$

$${f}_{Object} = {L}_{Location} + {U}_{Usage} \qquad eq 4$$

$${f}_{Object} = {U}_{Usage} \qquad eq 5$$

The system 102 may be configured to identify a target space in the environment based on determined fitness scores of the objects. For example, if the system 102 determines that an object has low fitness score, the system 102 may consider a space occupied by such object(s) as the target space to make suitable modification in the environment. In an embodiment, in order to determine low fitness score, the system 102 may compare the determined fitness score to a previously determined fitness score of the object or a predefined fitness score threshold of the object. For example, if the determine value of fitness score is less than the previously determined fitness score of the object or the predefined fitness score threshold of the object, the system 102 may consider that the object as low fitness score. The target space may be a part of environment having dimension suitable to accommodate the target object(s). The target space may be formed by combining space occupied by multiple objects or by splitting the space. For example, the system 102 may identify the space occupied by the chairs and the table as the target space.

The system 102 may be configured to generate an object arrangement for the target space based on the environment. The object arrangement may include a re-arrangement of at least one of the one or more identified objects, a replacement of the at least one of the one or more identified objects, or an addition of a new object at the target space. The system 102 may consider various parameters while generating the object arrangement. For example, the system 102 may consider parameters such as, but not limited to, a type of object located at the target space, an orientation of the object at the target space, a position of the object at the target space, neighboring objects, user activities, user interest, user-related events, characteristics of the environment and so forth. For example, the system 102 may be configured to determine that the user has an interest in adventurous activities based on the content viewing history of the user. Based on the determination of user interest, the system 102 may determine recommendation(s) to replace chairs and table located at the target space with a camp and trees 108, as depicted in FIG. 1.

In various embodiments, before recommending the determined object arrangement to the user, the system 102 may determine a first ambience score of the environment based on the currently identified objects and a second ambience score of the environment based on the generated object arrangement. The system 102 may compare the first ambience score and the second ambience score. The system 102 may recommend an ambience suggestion to the user based on the generated object arrangement (or re-arrangement) upon determining that the second ambience score is greater than the first ambience score.

In an embodiment, the system 102 may generate a virtual environment representing the environment with the suggested object arrangement. The virtual environment may be displayed to the user via any suitable device such as, but not limited to, the television 103, a mobile device of the user, a virtual reality (VR) device of the user, and so forth. The system 102 may display the object arrangement 108 in the environment via the television 103.

The system 102 may enhance user experience and personalization of the environment. The system 102 may effectively manage user ambience which may improve user's wellbeing by suggesting ambience modifications which improves user productivity, user lifestyle, and user mental health.

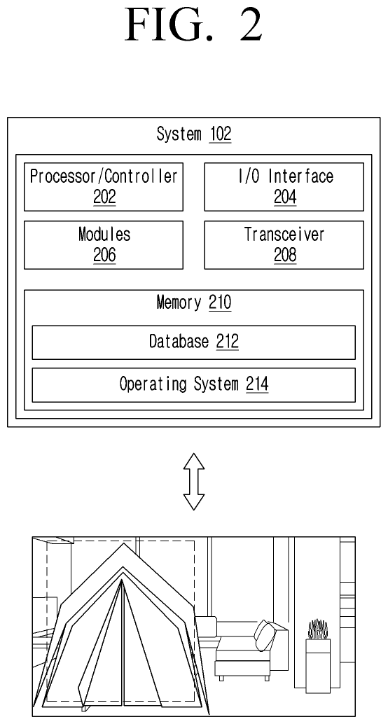

FIG. 2 is a block diagram illustrating an example configuration of the system 102 for generating the ambience suggestion for the environment, according to various embodiments. In an embodiment, the system 102 may be included within an electronic/user device associated with a user, for example, a television or a mobile phone. In an embodiment, the system 201 may be configured to operate as a standalone device or a system based in a server/cloud architecture communicably coupled to the electronic device/user device associated with the user. Examples of the electronic device may include, but not limited to, a mobile phone, a smart watch, a laptop computer, a desktop computer, a Personal Computer (PC), a notebook, a tablet, a mobile phone, an IoT device, or any other smart device communicably coupled to the camera device 104.

The system 102 may be configured receive and process image frames captured by the camera device 104 to generate ambience suggestion for the environment of the user. The system 102 may include a processor/controller (e.g., including processing circuitry) 202, an Input/Output (I/O) interface (e.g., including input/output circuitry) 204, one or more modules (e.g., including various circuitry and/or executable program instructions) 206, a transceiver 208, and a memory 210.

In an example embodiment, the processor/controller 202 may be operatively coupled to each of the I/O interface 204, the modules 12, the transceiver 208 and the memory 210. In an embodiment, the processor/controller 202 may include at least one data processor for executing processes in Virtual Storage Area Network. The processor/controller 202 may include specialized processing units such as, integrated system (bus) controllers, memory management control units, floating point units, graphics processing units, digital signal processing units, etc. In an embodiment, the processor/controller 202 may include a central processing unit (CPU), a graphics processing unit (GPU), or both. The processor/controller 202 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 202 may execute a software program, such as code generated manually (e.g., programmed) to perform the desired operation

The processor/controller 202 may be disposed in communication with one or more input/output (I/O) devices via the I/O interface 204. The I/O interface 204 may include various input/output circuitry and employ communication code-division multiple access (CDMA), high-speed packet access (HSPA+), global system for mobile communications (GSM), long-term evolution (LTE), WiMax, or the like, etc.

Using the I/O interface 204, the system 102 may communicate with one or more I/O devices. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc. In an embodiment, the system 201 may communicate with the electronic device associated with the user using the I/O interface 204.

The processor/controller 202 may be disposed in communication with a communication network via a network interface. In an embodiment, the network interface may include the I/O interface 204. The network interface may include various circuitry connect to the communication network to enable connection of the system 102 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 102 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In an example embodiment, the processor/controller 202 may receive image frame(s) corresponding to the environment from the camera device 104. The processor/controller 202 may execute a set of instructions on the received image frames to recommend ambience suggestion(s) to the user to improve the environment. The processor/controller 202 may implement various techniques such as, but not limited to, data extraction, Artificial Intelligence (AI), and so forth to achieve the desired objective(s) (for example, to enhance user experience and personalization of the environment).

In various embodiments, the memory 210 may be communicatively coupled to the at least one processor/controller 202. The memory 210 may be configured to store data, instructions executable by the at least one processor/controller 202. In an embodiment, the memory 210 may communicate via a bus within the system 201. The memory 210 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the processor/controller 202. In various examples, the memory 210 is separate from the processor/controller 202, such as a cache memory of a processor, the system memory, or other memory. The memory 210 may be an external storage device or database for storing data. The memory 210 may be operable to store instructions executable by the processor/controller 202. The functions, acts or tasks illustrated in the figures or described may be performed by the programmed processor/controller 202 for executing the instructions stored in the memory 210. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In various embodiments, the modules 206 may be included within the memory 210. The memory 210 may further include a database 212 to store data. The one or more modules 206 may include a set of instructions that may be executed to cause the system 201 to perform any one or more of the methods/processes disclosed herein. In various embodiments, the modules 206 may be configured to perform one or more operations of the processor 202 to achieve the desired objective of the present disclosure. The one or more modules 206 may be configured to perform the steps of the present disclosure using the data stored in the database 212, to generate ambience recommendation for the environment as discussed herein. In an embodiment, each of the one or more modules 206 may be a hardware unit which may be outside the memory 210. Further, the memory 210 may include an operating system 214 for performing one or more tasks of the system 201, as performed by a generic operating system in the communications domain. The transceiver 208 may include various communication circuitry and be configured to receive and/or transmit signals to and from the electronic device associated with the user. In an embodiment, the database 212 may be configured to store the information as required by the one or more modules 206 and the processor/controller 202 to perform one or more functions for determining semantic points in a human-to-human conversation.

The disclosure contemplates a computer-readable medium that includes instructions or receives and executes instructions responsive to a propagated signal. The instructions may be transmitted or received over the network via a communication port or interface or using a bus (not shown). The communication port or interface may be a part of the processor/controller 202 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 102 may be physical or may be established wirelessly. The network may be directly connected to the bus.

In various embodiments, at least one of the plurality of modules 206 may be implemented through an Artificial Intelligence (AI) model. A function associated with AI may be performed through the non-volatile memory, the volatile memory, and the processor 202.

The processor 202 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor(s) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The one or a plurality of processors control the processing of the input data/images in accordance with a predefined operating rule or artificial intelligence (AI) model stored in the non-volatile memory and the volatile memory. The predefined operating rule or artificial intelligence model is provided through training or learning.

Being provided through learning may refer, for example, to, by applying a learning technique to a plurality of learning data, a predefined operating rule or AI model of a desired characteristic being made. The learning may be performed in a device itself in which AI according to an embodiment is performed, and/or may be implemented through a separate server/system.

The AI model may include a plurality of neural network layers. Each layer may have a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in a method for generating the ambience suggestion(s) for an environment of a user, the system 102 may use an artificial intelligence model to recommend various object arrangements for the environment. The system 102 may use the AI model to generate instructions for data obtained from various sensors. The processor 202 may perform a pre-processing operation on the data to convert into a form appropriate for use as an input for the artificial intelligence model. The artificial intelligence model may be obtained by training. “Obtained by training” may refer, for example, to a predefined operation rule or artificial intelligence model configured to perform a desired feature (or purpose) being obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction may refer to a technique of logically reasoning and predicting by determining information and includes, e.g., knowledge-based reasoning, optimization prediction, preference-based planning, or recommendation.

For the sake of brevity, the architecture, and standard operations of the operating system 214, the memory 210, the database 212, the processor/controller 202, the transceiver 208, the I/O interface 204, and the AI model are not discussed in detail.

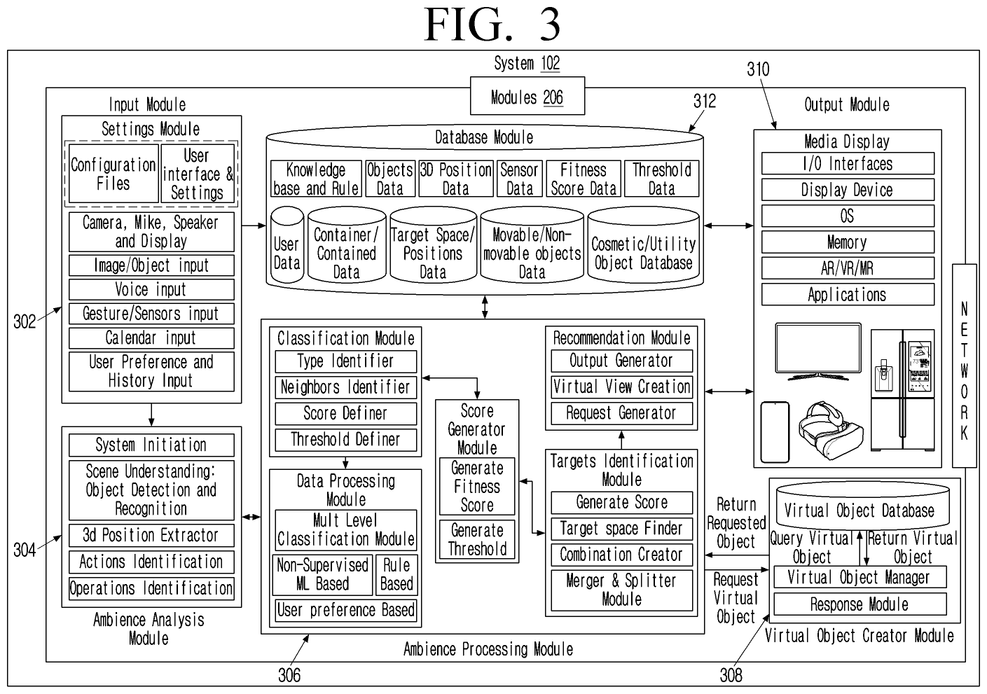

FIG. 3 is a block diagram illustrating example configurations of the modules 206 of the system 102 for generating the ambience suggestion for the environment, according to various embodiments.

The modules 206 may include various circuitry and/or executable program instructions and may include, for example, an input module 302, an ambience analysis module 304, an ambience processing module 306, a virtual object creator module 308, an output module 310, and a database module 312. The modules 304, 306, 308, 310, 312 may be communicably coupled to each other.

The input module 302 may be configured to generate one or more inputs required to generate the ambience suggestion. In an embodiment, the input module 302 may be configured to collect input data from user for the system 102. The input module 302 may act as an interface between various input devices and the system 102. Examples of input devices may include, but not limited to, a camera device, a microphone, a speaker, and a display. The input module 302 may be communicably coupled to the input devices to generate/receive various inputs, such as, but not limited to, image/object input, voice input, gesture/sensors input, calendar input, user preference and history input, and so forth. The image/object input may correspond to image frames captured by the camera device 104 and/or information associated with objects identified from the captured image frames. The voice input may be generated based on input received from microphone. The gesture/sensors input may be generated based on inputs from various sensors monitoring the user. The gesture/sensors input may include hand gestures, finger gestures, face gestures, eyes gestures and so forth. The calendar input may include information defining date/time for receiving various input data, for example image frames corresponding to the environment. Further, the user preference and history input may be based upon user viewing history on the television 103, user interest information such as, adventurous, sports, etc. The various information collected and/or generated by the input module 302 may be stored in the database module 312.

The input module 302 may include a settings sub-module configured to generate and/or store configuration files, user interfaces and settings. For example, the setting module may be configured to include predefined rules and user preference with respect to operation of the system 102 and/or the modules 206. In an embodiment, the input module 302 may store all the settings pertaining to a user in the user data section of the database module 312. The setting may include information such as, a threshold indicating a number of days to observe an event before generating a suggestion, user demographic data, user preferences, and so forth.

The system 102 may initialize the ambience analysis module 304. The ambience analysis module 304 may be configured to process the inputs received from the input module 302 and identify object(s) in the environment. The ambience analysis module 304 may be configured to determine parameters associated with the objects and/or environment. The parameters may include, but not limited to, object color, object material, object position, object orientation, user's lifestyle, lighting condition in the environment, available space in the environment, space consumption information, and so forth. The ambience analysis module 304 may also be configured to update the database module 312 based on the determined parameters. In various embodiments, the ambience analysis module 304 may use suitable object detection Application Programming Interface (API) to detect objects and the parameters of the environment. In various embodiments, the ambience analysis module 304 may use techniques such as, but not limited to, convolutional neural networks (Region-Based Convolutional Neural Networks), Fast R-CNN, and YOLO (You Only Look Once). The ambience analysis module 302 may be configured to transmit the generated information related to the objects and the parameters to the ambience processing module 306.

The ambience processing module 306 may be configured to receive information related to the objects and the parameters from the ambience analysis module 304. The ambience processing module 306 may be configured to process the received information to enable the system 102 to generate the ambience recommendation(s). The ambience processing module 306 may include various sub-modules namely, a classification module, a data processing module, a score generator module, a target identification module, and a recommendation module.

The classification module may include components, such as, but not limited to, a type identifier, a neighbor identifier, a score definer, threshold definer, and so forth. The type identifier may identify a type of each identified object in the environment. In an example embodiment, the objects may be classified into two types, namely container or contained. The container object may be configured to store various contained objects. For example, a bookshelf may be considered as a container object and books may be classified as contained objects. The neighbor identifier may be configured to identify neighboring objects corresponding to each identified object. Particularly, the neighbor identifier configured to determine a distance between objects to identify neighboring objects corresponding to each object. The score definer may be configured to define rules for determining a fitness score corresponding to each object. Further, the threshold definer may be configured to define a threshold for monitoring the user before recommending the ambience suggestion(s). For example, the system 102 may define the threshold as five days. In such a scenario, the system 102 may not recommend the user the generated ambience suggestion unless the system 102 monitors the user for at least five days. The classification module may be configured to transmit the generated information to the data processing module.

The data processing module may receive inputs from the classification module and perform different operations based on the type of objects. For example, the data processing module may be configured to perform multi-level classification of objects using non-supervised Machine Learning (ML) model for container type of object. For example, the data processing module may receive a cluster of objects as input and generate a similarity between the objects in the cluster. The data processing module may be configured to use rule-based model to process the contained type of objects. The data processing module may take contained type of objects as input and generate an association of such objects with the container object. In various embodiments, the objects may also be classified based on user preference and usage. The data processing module may be configured to use usage-based model to take image frames as input and generate the user preference and associated objects.

The score generator module may be configured to a fitness score corresponding to each identified object based the parameters associated with objects and/or environment. The score generator module may be configured to generate threshold corresponding to the fitness scores. Based on a comparison of the fitness with the generated threshold, the system 102 may determine a target space e.g., determine if the object needs to be replaced, removed, or modified. The score generator module may be configured to transmit the generated fitness scores and threshold to the target identification module.

The target identification module may be configured to generate a first ambience score based on the fitness scores of the identified objects in the environment. In an embodiment, the first ambience score may be a summation of fitness scores of all the identified objects in the environment. The target identification module may include a target space finder configured to identify a target space in the environment based on the determined fitness scores corresponding to the identified objects in the environment. The target identification module may include a combination creator configured to generate an object arrangement for the target space by creating a combination of different objects in the target space. The target identification module may also include merger and splitter module configured to merge or split the target space based to generate an effective object arrangement. The target identification module may be configured to identify target spaces and associated obstacles to determine whether to merge or split the target space. Examples of the target spaces may include, but not limited to, movable objects like table, chairs, etc., non-essential objects like painting, wall arts, etc., unused objects such as lamps, bookshelves, etc., and spaces selected by the user. Examples of the obstacles may include, but not limited to, non-moveable objects like beds, almirah etc., essential objects like monitor, computer, etc., and objects selected by the user. In various embodiments, the target identification module may also be configured to generate a second ambience score of the environment based on the generated object arrangement.

The ambience processing module 306 may also include a recommendation module configured to receive inputs from the target identification module and generate the ambience suggestion to the user. In various embodiments, the recommendation module may include an object generator configured to generate the ambience suggestion based at least a comparison of the first ambience score and the second ambience score, and the fitness scores corresponding to the objects. The recommendation module may include a request generator configured to generate a request for the virtual object creator module 308 to generate the virtual objects corresponding to the generated object arrangement. The virtual object creator module 308 may be responsible for performing operations to generate a virtual environment based the generated object arrangement and/or ambience suggestions. The virtual object creator module 308 may include a virtual object database including a plurality of virtual objects along with associated meta data. The virtual object creator module 308 may also include a virtual object manager configured to query the virtual object database for a virtual object based on the request received from the recommendation module. The virtual object database may return one or more virtual objects based on the query requests received from the virtual object manager. The virtual object creator module 308 may also include a response module configured to return the requested virtual object and/or virtual environment to the recommendation module and/or the ambience processing module 306. The recommendation module may receive the virtual object and/or virtual environment from the virtual object creator module 308. In an example embodiment, the recommendation module may only receive the virtual object from the virtual object creator module 308 and include a virtual view creator configured to generate a virtual environment using the received virtual object.

The ambience processing module 306 may be communicably coupled to the output module 310 configured to generate the ambience suggestion for the user and/or to display the generated virtual environment to the user. The output module 310 may include media devices such as, televisions, mobile devices, virtual reality headsets, refrigerators, or any other suitable ambience with a display. The media devices may also include components such as, but not limited to, I/O interfaces, display devices, operating systems, memory, AR/VR/MR modules, and so forth.

Each of the modules 302-310 may be communicably coupled to the database module 312 to store or retrieve information. The database module 312 may include knowledge-based information, rule-based information, object data, position data, sensor data, fitness scores, threshold data, as discussed throughout the disclosure. The database module 312 may also include user data, container/contained data, target space data, positions data, movable and/or non-movable object data, and utility-based data.

The modules 302-312 are described above by way of non-limiting example, and may interchange operations based on various requirements. In various embodiments, one or more operations of the modules 302-312 may be performed by the processor 202. The modules 206 may be coupled with an external device using a network.

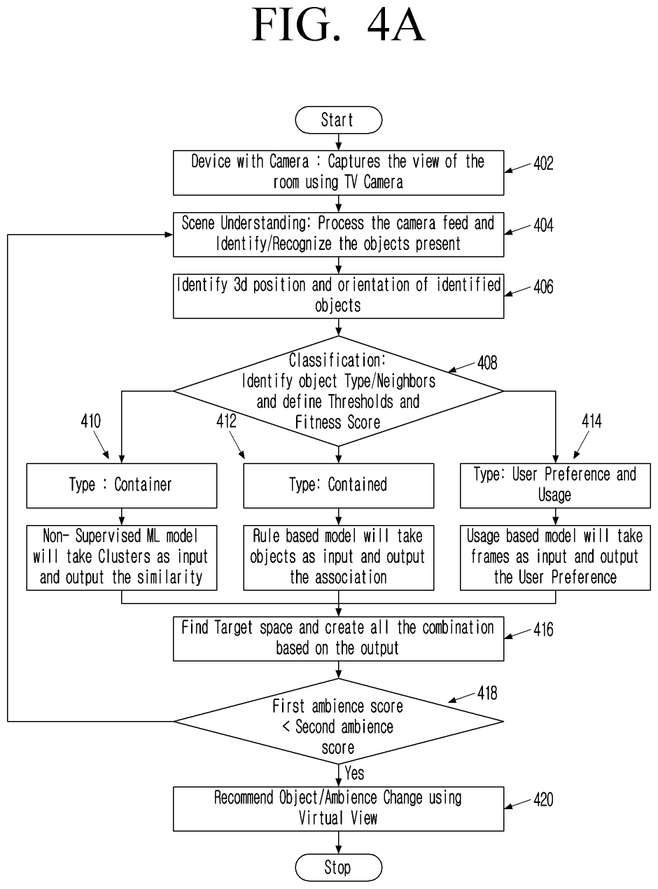

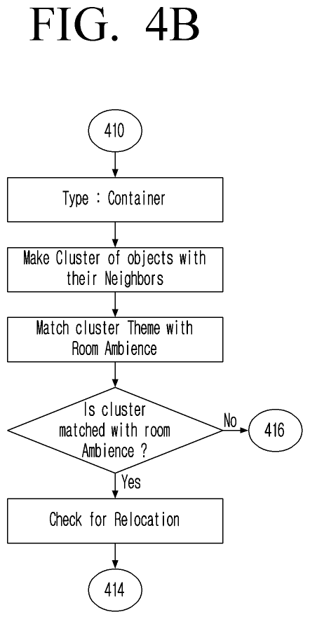

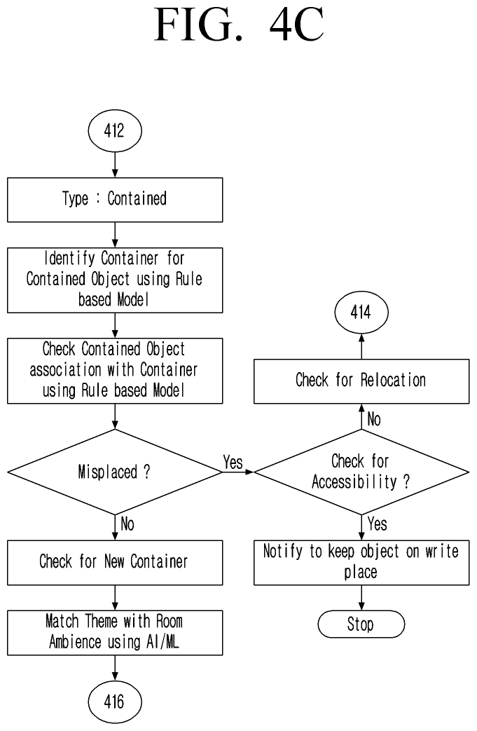

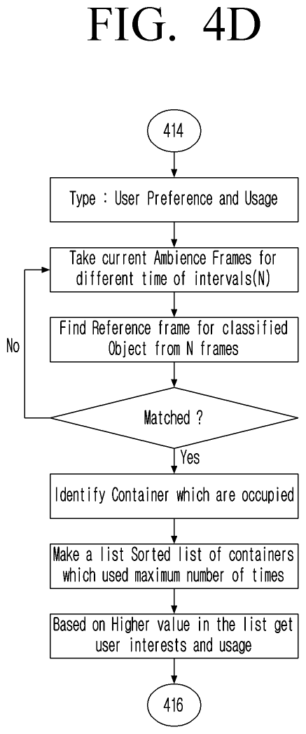

FIGS. 4A, 4B, 4C and 4D illustrate a flowchart 400 illustrating example operations for generating the ambience suggestion(s) for the environment, according to various embodiments.

At step 402, the camera device 104 may capture the environment and generate image frames corresponding to the environment. At step 404, the system 102 may perform scene understanding based on the image frames generated by the camera device 104. For example, the system 102 may process the image frames to identified object(s) of the environment. At step 406, the system 102 may identify a 3D position and orientation of each of the identified object in the environment.

At step 408, the system 102 may determine which category an identified object may correspond to. The system 102 may, for example, classify each of the identified objects into three types namely, container object, contained object, and user preference and usage-based object. The system 102 may also identify neighboring objects corresponding to each of the identified object. The system 102 may define threshold for generating recommendation. The threshold may define a number of days the system 102 need to monitor the environment before generating the ambience suggestion. The system 102 may also determine a fitness scores corresponding to each identified object. The system 102 may identify a first ambience score based on the determined fitness scores. The system 102 may determine a predefined fitness score threshold and compare the fitness score of each object with the predefined fitness score threshold. The system 102 may identify one or more object as target objects based on said comparison of fitness score with the predefined fitness score threshold. For example, the system 102 may identify an object as a target object when the comparison of the fitness score of said object with the predefined fitness score threshold indicates that the fitness score is below the predefined fitness score threshold. In an example embodiment, the system 102 may identify a type of the target object. Upon determining, the type of the target object as “container”, the system 102 may perform steps at 410, for the type of target object as “contained”, the system 102 may perform steps at 412, and for the type of target object as “user preference and usage”, the system 102 may perform steps at 414.

At step 410, the system 102 may use non-supervised ML model to generate a similarity between the identified target object and the environment. At step 410, the system 102 may perform the sequence of operation as illustrated by FIG. 4B. For example, the system 102 may make a cluster of objects by combining the target object with the neighboring objects. The system 102 may determine a theme of cluster and compare the determined theme with the ambience of the environment. The system 102 may determine whether the determined cluster matches with the ambience of the environment or not based on comparison of the cluster theme with the ambience. Upon determining that that the determined cluster does not matches with the ambience of the environment, the system 102 may perform step 416. However, upon determining that the determined cluster matches with the ambience of the environment, the system 102 may determine if any relocation is required. The system 102 may move to step 414 where the system 102 may use a usage-based model to take image frames as input and generate an output indicating user preference.

At step 412, the system 102 may use rule-based model to take the contained type of target object as input and generate an output indicating a corresponding association of the target object with a container object. At step 412, the system 102 may perform the operations as illustrated by FIG. 4C. For example, the system 102 may identify a container for the target object using rule-based model. The rule-based model may be based on a set of rules defining a relationship of a plurality of contained objects and associated container object. The system 102 may also check for association of the target object with the identified container object. For example, the system 102 may check whether the target object is suitably placed, misplaced, not available or so forth. The system 102 may determine whether the target is misplaced. Upon determining that the target object is misplaced, the system 102 may determine whether the associated container is accessible or not. If the associated container object is accessible, the system 102 may notify the user to keep the target object at a right place e.g., at the container object. If the container is not accessible, the system 102 may check for relocation of the container object. In such scenario, the system 102 may move to step 414 where the system 102 may use a usage-based model to take image frames as input and generate an output indicating user preference.

Further, upon determining that the target object is not misplaced, the system 102 may determine a new container for the target object. The system 102 may match the theme of newly identified container with the ambience of the environment using any suitable technique such as, but not limited to, AI, ML and so forth. Last, the system 102 may move to step 416 where the system 102 may identify a target space based on the target object.

At step 414, the system 102 may use the usage-based model to take image frames as input and generate the output indicating user preference. For example, at step 414, the system 102 may perform the sequence of operation as illustrated by FIG. 4D. The system 102 may take different image frames corresponding to the environment and captured at different time intervals as input. The system 102 may identify a reference frame for the classified object/target object. The system 102 may determine whether the target object is misplaced in reference frame or not. If the target object is not misplaced in the reference frame, the system 102 may move back to capturing image frames of the environment. If the target object is misplaced, the system 102 may identify the container object which is occupied. Further, the system 102 may create a sorted list of container objects based on number of usage times. Further, the system 102 may determine a user interest based on a higher value of container object.

At step 416, the system 102 may identify the target space based on the target object. Further, the system 102 may generate all possible combinations of the object arrangements at the target space. The system 102 may generate ambience scores based on the different object arrangements. The system 102 may select an object arrangement with highest ambience score and consider the associated ambience score as the second ambience score. At step 418, the system 102 may compare the first ambience score and the second ambience score. Upon determining that the second ambience score is greater than the first ambience score, the system 102 may recommend object arrangement to the user, as shown in step 420. The system 102 may also generate a virtual view of generated object recommendation.

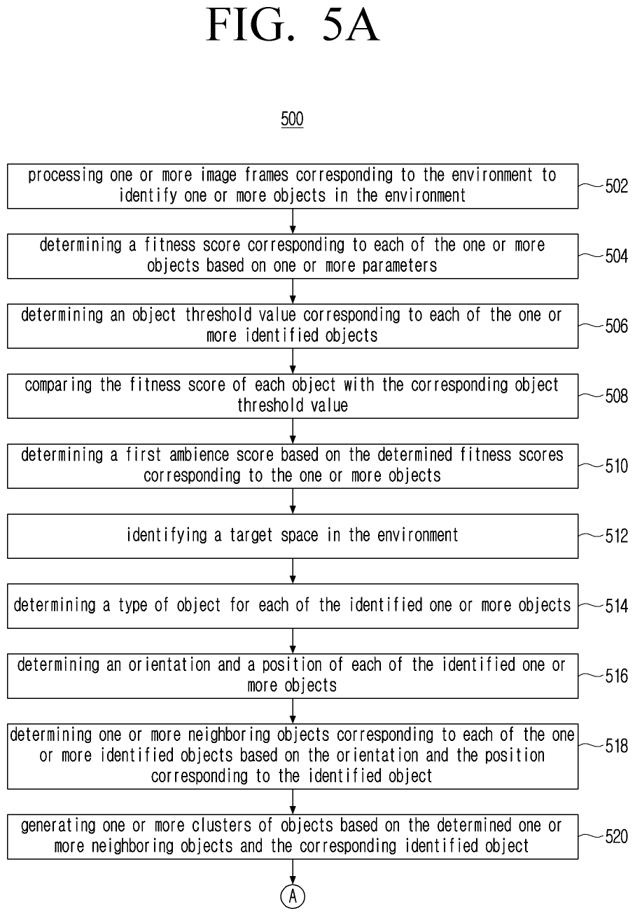

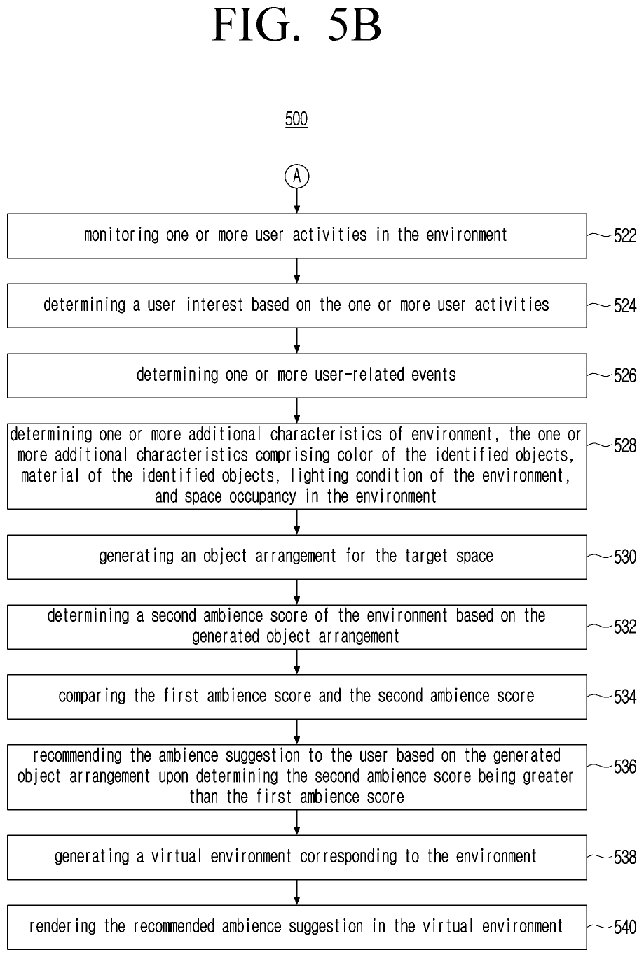

FIGS. 5A and 5B illustrate a flowchart illustrating an example method 500 for generating the ambience suggestion for the environment, according to various embodiments. The method 500 may be performed by the system 102.

At step 502, the method 500 includes processing one or more image frames corresponding to the environment to identify one or more objects in the environment. At step 504, the method 500 includes determining a fitness score corresponding to each of the one or more objects based on one or more parameters. In an embodiment, the one or more parameters comprises at least one of environment theme, user interest, object location, and object usage. At step 506, the method includes determining an object threshold value corresponding to each of the one or more identified objects. At step 508, the method 500 includes comparing the fitness score of each object with the corresponding object threshold value.

At step 510, the method 500 includes determining a first ambience score based on the determined fitness scores corresponding to the one or more objects. In an embodiment, the first ambience score may include a summation of the fitness scores corresponding to the one or more objects.

At step 512, the method 500 includes identifying a target space in the environment. At step 514, the method 500 includes determining a type of object for each of the identified one or more objects. At step 516, the method 500 includes determining an orientation and a position of each of the identified one or more objects.

At step 518, the method 500 includes determining one or more neighboring objects corresponding to each of the one or more identified objects based on the orientation and the position corresponding to the identified object. At step 520, the method 500 includes generating one or more clusters of objects based on the determined one or more neighboring objects and the corresponding identified object.

At step 522, the method 500 includes monitoring one or more user activities in the environment. At step 524, the method 500 includes determining a user interest based on the one or more user activities. At step 526, the method 500 includes determining one or more user-related events. At step 528, the method includes determining one or more additional characteristics of environment. The one or more additional characteristics comprising color of the identified objects, material of the identified objects, lighting condition of the environment, and space occupancy in the environment. At step 530, the method 500 includes generating an object arrangement for the target space. In an embodiment, the object arrangement may include a re-arrangement of at least one of the one or more identified objects, a replacement of the at least one of the one or more identified objects, or an addition of a new object at the target space.

At step 532, the method 500 includes determining a second ambience score of the environment based on the generated object arrangement. At step 534, the method 500 includes comparing the first ambience score and the second ambience score. At step 536, the method 500 includes recommending the ambience suggestion to the user based on the generated object arrangement upon determining the second ambience score being greater than the first ambience score.

At step 538, the method 500 includes generating a virtual environment corresponding to the environment. At step 540, the method 500 includes rendering the recommended ambience suggestion in the virtual environment.

While the above discussed steps in FIGS. 5A and 5B are shown and described in a particular sequence, the steps may occur in variations to the sequence in accordance with various embodiments.

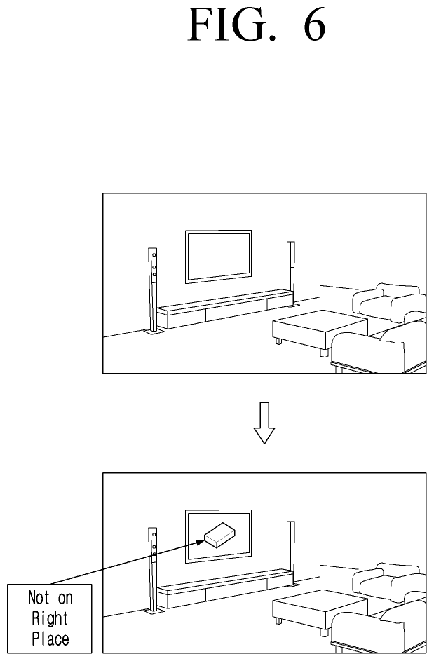

FIG. 6 is a diagram illustrating example generation of ambience suggestion(s) for the environment, according to various embodiments. In the illustrated embodiment, the system 102 may monitor a user environment for a period as defined by the threshold. The environment may correspond to a room. In an embodiment, the user may define the threshold. The system 102 may monitor that there is a bookshelf in the room and user keeps all the books in the bookshelf daily. However, one day the user leaves a book on the side table and forgets to keep the book on the shelf. The system 102 may monitor the behavior of the user for a number of days. Upon determining that the user has not placed the book at the bookshelf, the system 102 may generate an ambience suggestion as “not on right place”. The generated ambience suggestion(s) may be displayed to the user using the television monitoring the environment. The television may include the camera device 104 to determine displacement of the book. In various embodiments, the system 102 may observe that the user is keeping the books at the side table. Therefore, the system 102 may determine that the bookshelf is not accessible to the user. Based on said determination, the system 102 may suggest relocation of the bookshelf to make the bookshelf more accessible to the user. The system 102 may suggest replacement of the side table with the bookshelf. Thus, based on the suggestion(s) by the system 102, the user may properly place the book in the bookshelf, thereby able to effectively manage the environment.

In an example embodiment, to generate the ambience suggestion in above scenario, the system 102 may identify the book(s) (object) placed on the side table. The system 102 may identify a type of each book. For example, the system 102 may classify the book(s) as contained object. For each book, the system 102 may identify a corresponding container object, for example, the bookshelf. Further, the system 102 may identify a theme of the environment as “Bedroom?”

Upon determining the book(s) on the side table, the system 102 may generate a fitness score(s) of the book(s). The system 102 may classify user based on user interest as “Book Lover?” The system 102 may identify the side table as a target object. The system 102 may determine suitable replacement for the side table (the target object) as the bookshelf. Therefore, the system 102 may generate the ambience suggestion as “move book to bookshelf”. Further, with the placement of each book, the value of variable L_{Location} (as shown in Eq. 2) may increase which increases overall fitness score of the object/environment.

In an embodiment, the system 102 may generate a fitness score of the bookshelf. The system 102 may identify that the bookshelf is inaccessible. Thus, the system 102 may generate the ambience suggestion as “move the bookshelf to another place which is more accessible to the user”. Further, with the relocation of the bookshelf, the bookshelf may become more accessible to the user resulting in increase in value of variable L_{Location} (as shown in Eq. 2) which increases overall fitness score of the object/environment.

Thus, the system 102 may generate suggestions which result in varying the variables of fitness score to increase overall fitness score of the environment.

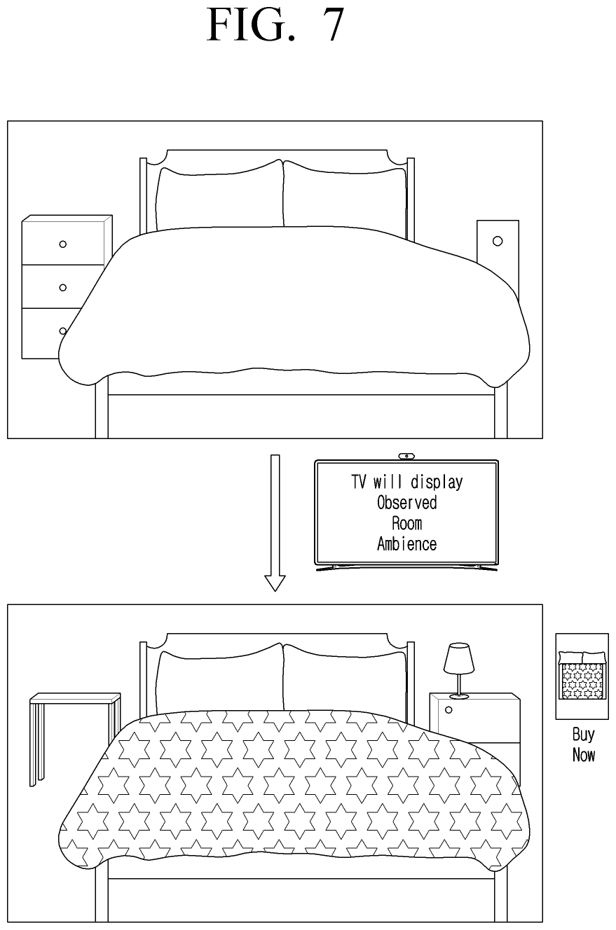

FIG. 7 is a diagram illustrating example generation of ambience suggestion(s) for the environment, according to various embodiments. In the illustrated embodiment, the system 102 may monitor an environment, for example, room ambience and determine the object “e.g., a bedsheet” does not match with the overall environment. The determination may be made based on a fitness score of the bedsheet in view of the environment. Therefore, to enhance overall ambience score of the environment, the system 102 may suggest another bedsheet which a higher fitness score.

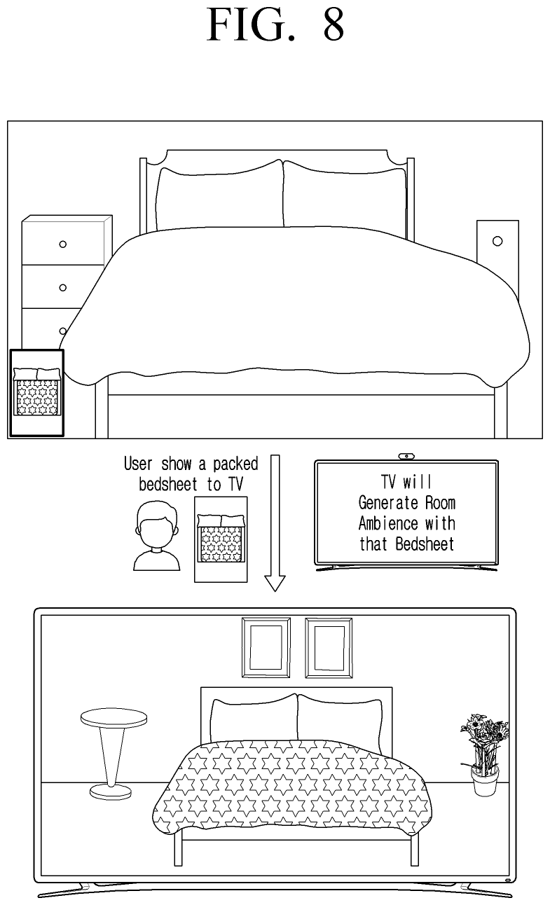

FIG. 8 is a diagram illustrating example generation of ambience suggestion(s) for the environment, according to various embodiments. In the illustrated embodiment, the system 102 may monitor the environment of the user. The user may display a packed bedsheet to the system 102. The system 102 may capture the image frame corresponding to displayed bedsheet. The system 102 may process the image frame to generate a virtual environment having the bedsheet on the bed. Thus, the system 102 may provide an effective way to visualize a change in the environment based on user's input.

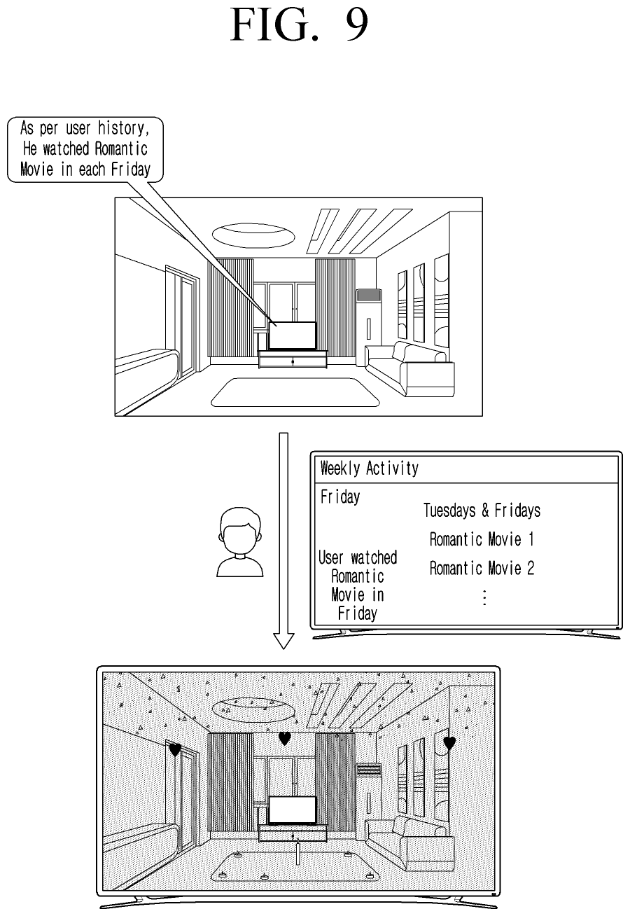

FIG. 9 is a diagram illustrating example generation of ambience suggestion(s) for the environment based on user activity, according to various embodiments. In the illustrated embodiment, the system 102 may monitor user's environment along with user viewing history. The system 102 may determine that the user watches romantic movies on Tuesday and Fridays. Therefore, based on said determination, the system 102 may generate an ambience suggestion as addition of components with romantic theme to enhance user experience.

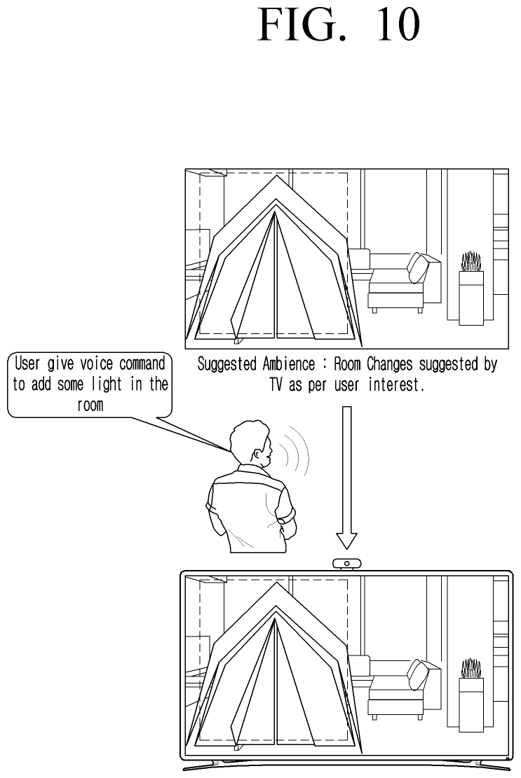

FIG. 10 is a diagram illustrating example generation of ambience suggestion(s) for the environment based on user voice command, according to various embodiments. In the illustrated embodiment, the system 102 may receive a voice command from the user “e.g., change the table lamp position and add some light”. The system 102 may process said command from the user and generate the ambience suggestion based on received command.

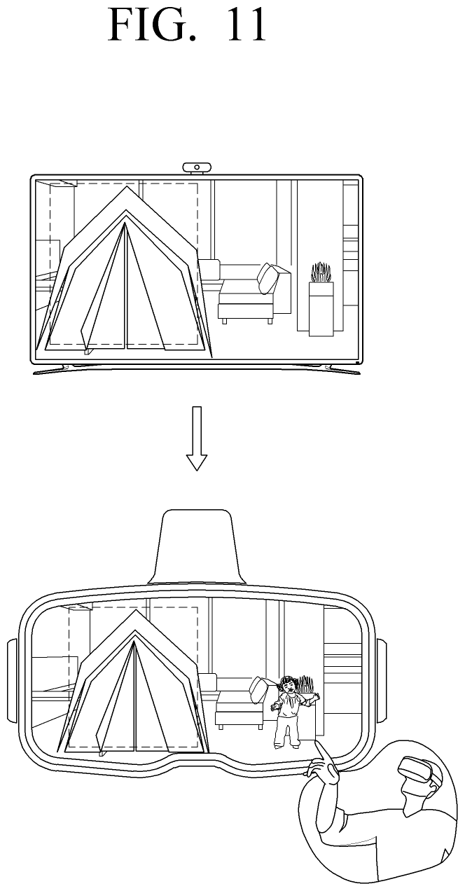

FIG. 11 is a diagram illustrating example generation of ambience suggestion for the environment in a virtual reality device, according to various embodiments. In the illustrated embodiment, the system 102 may generate the ambience suggestion at the wearable virtual reality headset of the user, to provide the user interactive experience with the modified environment.

The system 102 may be configured to identify a misplaced object inside an environment and suggest a user to place object at a right place. The system 102 may identify objects which do not matches with environment theme and also suggest suitable replacement/relocation of such objects. The system 102 may be able to provide personalized ambience to a user based on user interest and command.

Embodiments of the disclosure provide various technical advancements based on the key features discussed above. For example, embodiments of the disclosure may provide well-managed and personalized environment to the user. Embodiments of the disclosure may also enable a user to visualize a change in the environment in an interactive way “e.g., based on voice command or user gestures”. Embodiments of the disclosure may lead to enhancement with user's well-being by providing an environment which is user-friendly, aesthetically pleasing and effectively managed.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for generating an ambience suggestion for an environment, the method comprising:
processing one or more image frames corresponding to the environment to identify one or more objects in the environment;
determining a fitness score corresponding to each of the one or more objects based on one or more parameters;
determining a first ambience score based on the determined fitness scores corresponding to the one or more objects;
identifying a target space in the environment based on the determined fitness scores corresponding to the one or more objects;
generating an object arrangement for the target space based on the environment;
determining a second ambience score of the environment based on the generated object arrangement;
comparing the first ambience score and the second ambience score; and
recommending the ambience suggestion based on the generated object arrangement based on determining that the second ambience score is greater than the first ambience score, wherein the ambience suggestion indicates a change in the environment based on the generated object arrangement.

2. The method as claimed in claim 1, wherein the one or more parameters comprises at least one of environment theme, user interest, object location, and object usage.

3. The method as claimed in claim 1, wherein the first ambience score comprises a sum of the fitness scores corresponding to the one or more objects.

4. The method as claimed in claim 1, wherein the object arrangement includes a re-arrangement of at least one of the one or more identified objects, a replacement of the at least one of the one or more identified objects, or an addition of a new object at the target space.

5. The method as claimed in claim 1, comprising:
determining an object threshold value corresponding to each of the one or more identified objects;
comparing the fitness score of each object with a corresponding object threshold value; and
identifying the target space in the environment based on the comparison of the first score of each object with the corresponding object threshold value.

6. The method as claimed in claim 1, comprising:
determining a type of object for each of the identified one or more objects;
determining an orientation and a position of each of the identified one or more objects;
determining one or more neighboring objects corresponding to each of the one or more identified objects based on the orientation and the position corresponding to the identified object;
generating one or more clusters of objects based on the determined one or more neighboring objects and the corresponding identified object; and
generating the object arrangement for the target space based at least on the type of object corresponding to the identified one or more objects at the target space and the generated one or more clusters of objects for the corresponding identified one or more objects at the target space.

7. The method as claimed in claim 5, wherein the type of object comprises one of a container object and a contained object.

8. The method as claimed in claim 1, comprising:
monitoring one or more user activities in the environment;
determining a user interest based on the one or more user activities; and
generating the object arrangement for the target space based on the determined user interest.

9. The method as claimed in claim 1, comprising:
determining one or more user-related events; and
generating the object arrangement for the target space based on the one or more user-related events.

10. The method as claimed in claim 1, comprising:
determining one or more additional characteristics of environment, the one or more additional characteristics comprising color of the identified objects, material of the identified objects, lighting condition of the environment, and/or space occupancy in the environment; and
generating the object arrangement for the target space based on the one or more additional characteristics of environment.

11. The method as claimed in claim 1, comprising:
generating a virtual environment corresponding to the environment; and
rendering the recommended ambience suggestion in the virtual environment.

12. A system configured to generate an ambience suggestion for an environment, the system comprising:
a memory;
at least one processor, comprising processing circuitry, operably coupled to the memory, wherein at least one processor, individually and/or collectively, is configured to:
process one or more image frames corresponding to the environment to identify one or more objects in the environment;
determine a fitness score corresponding to each of the one or more objects based on one or more parameters;
determine a first ambience score based on the determined fitness scores corresponding to the one or more objects;
identify a target space in the environment based on the determined fitness scores corresponding to the one or more objects;
generate an object arrangement for the target space based on the environment;
determine a second ambience score of the environment based on the generated object arrangement;
compare the first ambience score and the second ambience score; and
recommend the ambience suggestion based on the generated object arrangement based on determining that the second ambience score is greater than the first ambience score, wherein the ambience suggestion indicates a change in the environment based on the generated object arrangement.

13. The system as claimed in claim 12, wherein the one or more parameters comprises at least one of environment theme, user interest, object location, and object usage.

14. The system as claimed in claim 12, wherein the first ambience score comprises a sum of the fitness scores corresponding to the one or more objects.

15. The system as claimed in claim 12, wherein the object arrangement includes a re-arrangement of at least one of the one or more identified objects, a replacement of the at least one of the one or more identified objects, or an addition of a new object at the target space.

16. The system as claimed in claim 12, comprising:
determine an object threshold value corresponding to each of the one or more identified objects;
compare the fitness score of each object with a corresponding object threshold value; and
identify the target space in the environment based on the comparison of the first score of each object with the corresponding object threshold value.

17. The system as claimed in claim 12, comprising:
determine a type of object for each of the identified one or more objects;
determine an orientation and a position of each of the identified one or more objects;
determine one or more neighboring objects corresponding to each of the one or more identified objects based on the orientation and the position corresponding to the identified object;
generate one or more clusters of objects based on the determined one or more neighboring objects and the corresponding identified object; and
generate the object arrangement for the target space based at least on the type of object corresponding to the identified one or more objects at the target space and the generated one or more clusters of objects for the corresponding identified one or more objects at the target space.

18. The system as claimed in claim 16, wherein the type of object comprises one of a container object and a contained object.

19. The system as claimed in claim 12, comprising:
monitor one or more user activities in the environment;
determine a user interest based on the one or more user activities; and
generate the object arrangement for the target space based on the determined user interest.

20. The system as claimed in claim 12, comprising:
determine one or more user-related events; and
generate the object arrangement for the target space based on the one or more user-related events.
